(19) United States
(12) Patent Application Publication
(10) Pub. No.: US 2009/0316190 A1
(43) Pub. Date: Dec. 24, 2009

(54) IMAGE FORMING SYSTEM, IMAGE FORMING APPARATUS, PRINT SERVER, IMAGE FORMING METHOD, AND COMPUTER READABLE RECORDING MEDIUM STORED WITH IMAGE FORMING PROGRAM

(75) Inventors: Michihiro Nakagawa, Sagamihara-shi (JP); Tamotsu Sakuraba, Sagamihara-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/406,220

(22) Filed: Mar. 18, 2009

(30) Foreign Application Priority Data
Jun. 19, 2008 (JP) 2008-159949

(51) Int. Cl. G06F 3/12

(52) U.S. Cl. 358/1.15

(57) ABSTRACT

If a user's instruction concerning at least one of print interruption and print cancellation is received by one of a plurality of printers while a print job is being executed split among the plurality of printers, a command for causing other printer that is executing printing processes based on the print job corresponding to the printing to execute a processes corresponding to the instruction is issued from the one of the plurality of printers.

### CROSS-REFERENCE TO RELATED APPLICATION

This application is based on Japanese Patent Application No. 2008-159949 filed on Jun. 19, 2008, the contents of which are incorporated herein by reference.

### BACKGROUND

1. Technical Field

The present invention relates to an image forming system, an image forming apparatus, a print server, an image forming method, and a computer readable storage medium stored with an image forming program. The present invention relates, in particular, to an image forming system, an image forming apparatus, a print server, an image forming method, and a computer readable storage medium stored with an image forming program for executing a print job by splitting it among a plurality of image forming apparatuses.

2. Description of Related Art

Cluster printing is known as a means of shortening printing time by splitting a print job among a plurality of image forming apparatuses such as printers. See Unexamined Japanese Patent Publication No. 2005-25308.

According to the art described in the abovementioned patent document, in case where a print job split among a plurality of printers is in progress, the print job running on all printers can be cancelled simultaneously by an instruction from the print server that is managing the print job.

Incidentally, it often happens that a user finds errors in printed matters, e.g., errors related to both side printing instructions, color printing instructions, finishing process instructions, and others at locations where printers being used in cluster printing are installed.

In case of the art described in the abovementioned patent document, however, even a case where the user wants to cancel the print job as an error is found in the print job, the printing cannot be cancelled unless the user actually moves to the print server location to operate it. This is a problem as each printer keeps printing while the user moves to the server, wasting consumable items such as paper and toner. Naturally, the more printers are involved for split printing, the more consumable items are wasted, increasing the printing cost.

### SUMMARY

It is an object of the present invention to provide an image forming system, an image forming apparatus, a print server, an image forming method, and a computer readable recording medium stored with an image forming program, all of which are improved to solve at least one of the abovementioned problems.

It is another object of the present invention to provide an image forming system, an image forming apparatus, a print server, an image forming method, and a computer readable recording medium stored with an image forming program for a user to cancel printing quickly to minimize wasteful printing when an error is found while a print job is executed split among a plurality of image forming apparatuses.

To achieve at least one of the abovementioned objects, an image forming system capable of executing a print job by splitting the print job among a plurality of image forming apparatuses, reflecting one aspect of the present invention, comprises: an instructing unit for receiving a user's instruction concerning at least one of print interruption and print cancellation at one of said plurality of image forming apparatuses; and an issuing unit for issuing from said one particular image forming apparatus a command for causing other image forming apparatus, which is executing a printing process based on the print job corresponding to said printing among said plurality of image forming apparatuses, to execute a process corresponding to said instruction, when said instruction is received by said instruction unit.

It is preferable that said image forming system further comprises a selecting unit for receiving the user's selection as to whether or not to cause said other image forming apparatus to execute a process corresponding to said instruction when said instruction is received by said instructing unit, wherein said issuing unit issues said command when a selection to cause said other image forming apparatus to execute the process corresponding to said instruction is received by said selecting unit.

It is preferable that, in said image forming system, after said command is issued by said one particular image forming apparatus to a print server that manages the execution of said print job, said command is transmitted to said other image forming apparatus from said print server.

It is preferable that, in said image forming system, said command is issued by said one particular image forming apparatus to said other image forming apparatus.

It is preferable that, in said image forming system, said command is, after being issued to an image forming apparatus, which acts as a parent for splitting said print job among said plurality of image forming apparatuses, transmitted to said other image forming apparatus from said image forming apparatus acting as the parent.

It is preferable that, in said image forming system, the user's instruction concerning said at least one of print interruption and print cancellation contains the user's instruction for resuming the interrupted printing.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a diagram showing the overall constitution of an image forming system according to the first embodiment of the present invention.

FIG. 2 is a block diagram showing the general constitution of a print server.

FIG. 3 is a block diagram showing the general constitution of a printer.

FIG. 4 is a sequence chart for describing the outline of the operation of the image forming system concerning the first embodiment

FIG. 5 is a flowchart showing the procedure of the print start command transmission process on the print server.

FIG. 6 is a flowchart showing the procedure of the print start command transmission process on the print server continued from FIG. 5.

FIG. 7 is a flowchart showing the procedure of the print start command transmission process on the print server continued from FIG. 6.

FIG. 8 is a diagram showing an example of the sever-side job management information.

FIG. 9 shows an example of the printer information.

FIG. 10 is a diagram showing an example of the print start command.

FIG. 11 is a flowchart showing the procedure of the print start command reception process on the printer.

FIG. 12 is a diagram showing an example of the printer-side job management information.

FIG. 13 is a flowchart showing the sequence of the print interruption process on the printer.

FIG. 14 is a flowchart showing the procedure of the print cancellation process on the printer.

FIG. 15 is a flowchart, continued from FIG. 14, showing the procedure of the print cancellation process on the printer continued from FIG. 14.

FIG. 16 is a diagram showing an example of the first selection screen.

FIG. 17 is a diagram showing an example of the second selection screen.

FIG. 18 is a flowchart showing the procedure of the process of command reception from the printer on the print server.

FIG. 19 is a flowchart showing the procedure of the process of command reception from the printer on the print server continued from FIG. 18.

FIG. 20 is a flowchart showing the procedure of the process of cancellation/interruption/resuming command reception from the printer on the print server.

FIG. 21 is a sequence chart for describing the outline of the operation of the image forming system concerning the second embodiment of the present invention.

FIG. 22 is a flowchart showing the sequence of the print interruption process on the printer in the second embodiment.

FIG. 23 is a diagram showing an example of the third selection screen.

FIG. 24 is a diagram showing an example of the fourth selection screen.

FIG. 25 is a sequence chart for describing the outline of the operation of the image forming system concerning the third embodiment of the present invention.

FIG. 26 is a sequence chart for describing the outline of the operation of the image forming system concerning the fourth embodiment of the present invention.

### DETAILED DESCRIPTION

The preferred embodiments of the invention will be described in detail below with reference to the accompanying drawings.

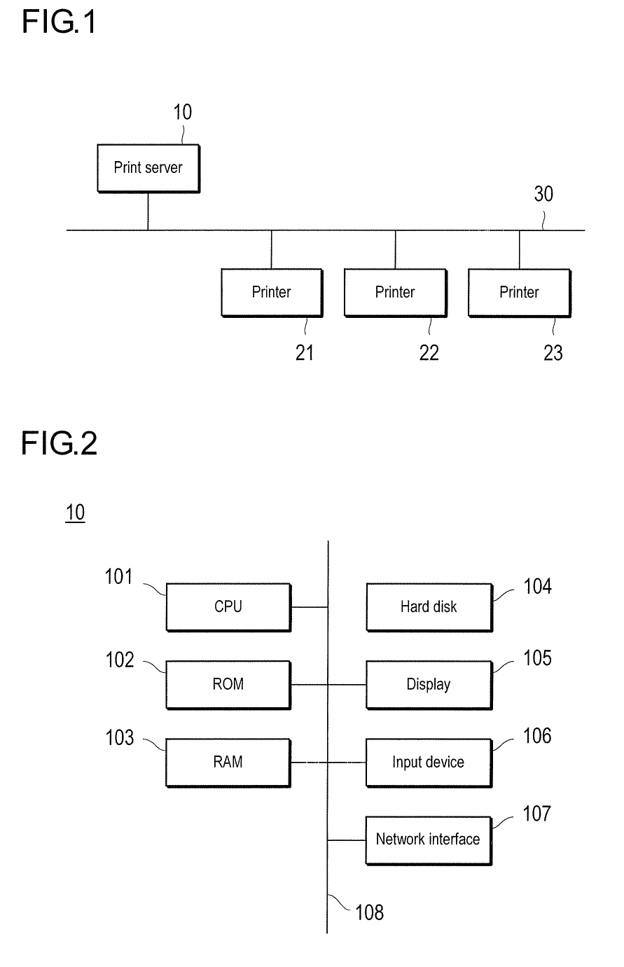

FIG. 1 is a diagram showing the overall constitution of an image forming system according to a first embodiment of the present invention.

As shown in FIG. 1, the image forming system comprises a print server 10 and a plurality of printers 21 through 23, all of which are interconnected to be able to communicate with each other via a network 30. The network 30 can be a LAN connecting computers and network equipment according to standards such as Ethernet, Token Ring, and FDDI, or a WAN that consists of several LANs connected by a dedicated line.

The print server 10 and the printers 21-23 can be connected via a dedicated interface bus such as IEEE 1394 serial bus and USB (Universal Serial Bus).

The types and the number of equipment to be connected to the network 30 are not limited to those shown in FIG. 1. Although three printers are connected in this embodiment, the number of the printers is not limited to three but can be any number.

Next, constitution of each apparatus mentioned above will be described below, but the description of a function common to multiple apparatuses will be made only once when it first appears and will not be repeated afterwards in order to avoid duplicate descriptions.

FIG. 2 is a block diagram showing the general constitution of the print server 10. The print server 10 is a server computer for the printers.

The print server 10 contains a CPU 101, a ROM 102, a RAM 103, a hard disk 104, a display 105, an input device 106 and a network interface 107, all of which are interconnected by a bus 108 for exchanging signals.

The CPU 101 controls various parts indicated above and executes various arithmetic processes according to a program. The ROM 102 stores various programs and data. The RAM 103 stores programs and data temporarily as a working area. The hard disk 104 stores various programs including an operating system and data.

The display 105 is typically a LCD or a CRT and displays various kinds of information. The input device 106 includes a pointing apparatus such as a mouse, a keyboard, and others, and is used for executing various kinds of inputs. The network interface 107 is typically a LAN card and is used for communicating with external equipment via the network 30.

The hard disk 104 stores print jobs received from client terminals not shown. The hard disk 104 stores a program that splits a print job (parent print job) into a plurality of child print jobs and causes them to be executed by a plurality of printers.

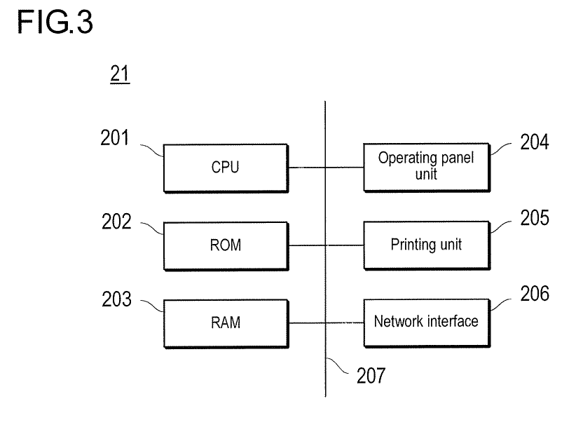

FIG. 3 is a block diagram showing the general constitution of a printer 21. The printer 21 prints images on paper based on a child print job generated by the print sever 10 based on an instruction from the print server 10. Since the printers 22 and 23 have similar constitutions as the printer 21, their descriptions are omitted.

The printer 21 has a CPU 201, a ROM 202, a RAM 203, an operating panel unit 204, a printing unit 205, and a network interface 206, all of which are interconnected with each other via a bus 207 for exchanging signals.

The operating panel unit 204 is used for various information displays and for entering various instructions. The printing unit 205 prints image data on recording media such as paper using a known imaging process such as the electronic photographing process including such processes as electrical charging, exposure, developing, transferring and fixing.

The print server 10 and the printers 21-23 may contain constitutional elements other than those described above, or may not include a portion of the abovementioned elements.

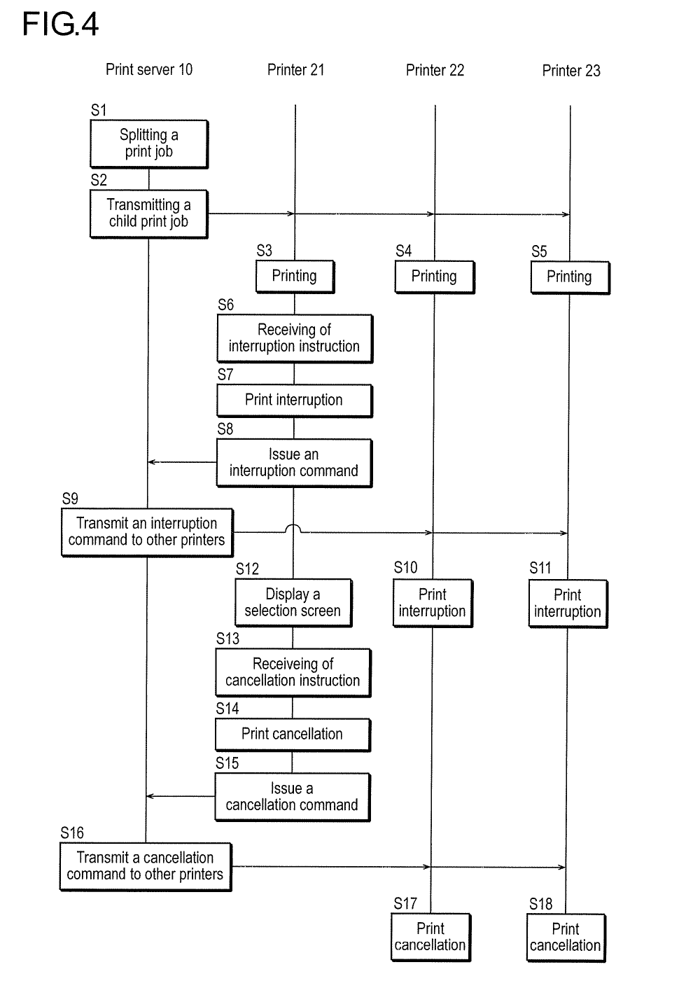

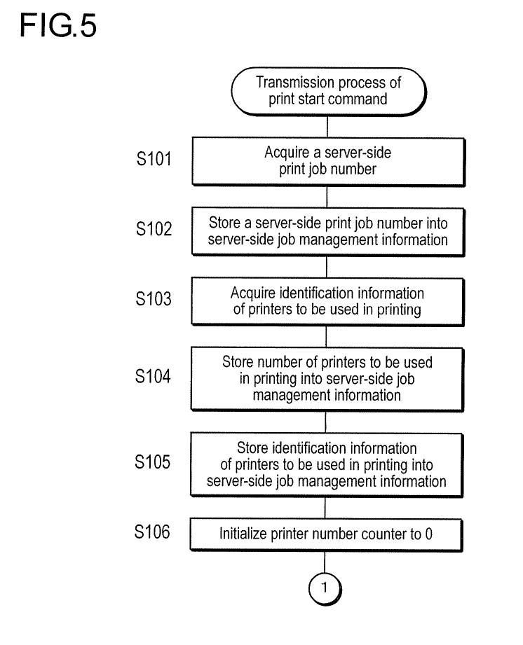

Next, the outline of the operation of the image forming system of the first embodiment will be described with reference to the sequence chart of FIG. 4.

FIG. 4 shows a case |where| a user is trying to interrupt (temporary halt) and canceling the printing as he finds an error in printed materials at the location where the printer 21 is installed while the three printers 21-23 are used for cluster printing based on child print jobs transmitted from the printer server 10. The error in the printed material include errors in printing instructions such as an instruction of both side printing, an instruction of color printing, and an instruction of finishing process.

First, the print server 10 splits the print job to be executed (S1), forms a plurality of child print jobs, and transmits them to the printers 21-23 individually (S2).

|Cluster printing can be executed in a form where data consisting of a plurality of pages is concurrently transmitted to a plurality of printers for printing a plurality of copies, or can be executed in a form where data consisting of a plurality of pages is divided and concurrently transmitted to a plurality of printers for printing a single copy.|

Each of the printers 21-23 prints based on the child print job each received (S3-S5).

Then, as the user realizes an error in printed materials at the installation location of the printer 21, the printer 21 receives an instruction for print interruption based on the user's operation (S6).

Next, the printer 21 not only interrupts its printing operation (S7), but also issues to the print server 10 an interruption command for causing other printers 22 and 23 to interrupt their printing operations as well (S8).

Receiving the interruption command from the printer 21, the print server 10 transmits the interruption command to cause the printers 22 and 23 to interrupt printing to the particular printers 22 and 23 (S9).

Receiving the interruption command from the printer server 10, the printers 22 and 23 interrupt their printing operations (S10 and S11).

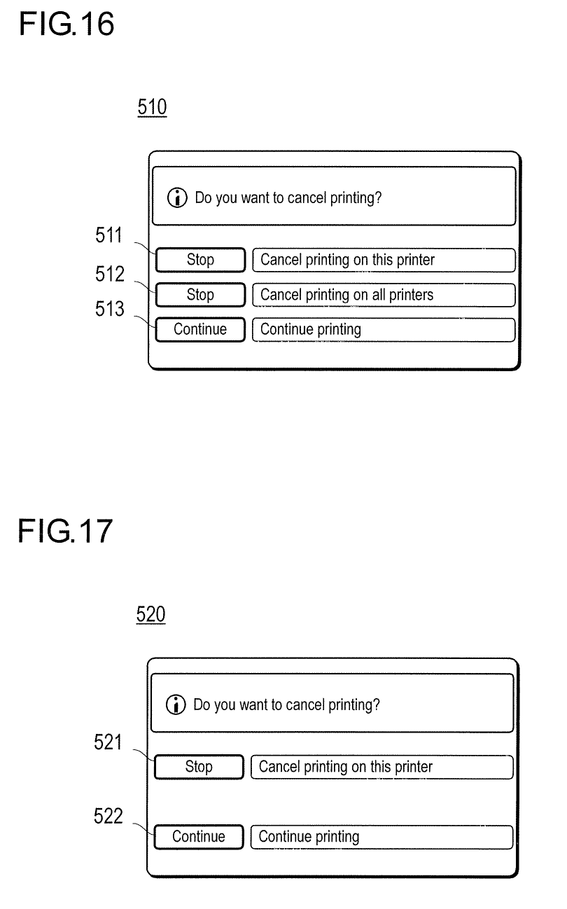

After the print interruption, the printer 21 displays a selection screen on the operating panel unit 204 for receiving the user's selection whether to cancel its printing operation, or to cancel the printing operations on all printers used in the cluster printing, or to allow the printing operations to continue (refer to FIG. 16).

Let us describe here the case in which a selection of canceling the printing operation on all printers used for the cluster printing is received (S13). In this case, the printer 21 not only cancels its printing operation (S14), but also issues to the print server 10 a cancellation command for executing a print cancellation process on other printers 22 and 23 that are being used for the cluster printing (S15).

Receiving the cancellation command from the printer 21, the print server 10 transmits the cancellation command to the printers 22 and 23 to execute a print cancellation process on the particular printers 22 and 23 (S16).

Receiving the cancellation command from the printer server 10, the printers 22 and 23 cancel their printing operations (S17 and S18).

Next, the operations of various apparatuses of the image forming system will be described in detail.

FIG. 5 through FIG. 7 constitute a flowchart showing the procedure of the print start command transmission process on the print server 10. The algorithm illustrated by the flowchart of FIG. 5 through FIG. 7 is stored as a program in a storage unit such as the hard disk 104 of the print server 10, read out to the RAM 103 and executed by the CPU 101 when the operation starts.

The print server 10 acquires a job number assigned to the print job to be executed, i.e., the server side print job number (S101).

The acquired server side print job number is stored in the server side job management information for which a memory area is reserved and managed in the print server 10 (S102).

Next, the identification information of the printers used in the cluster printing is acquired (S103). The printers used in the cluster printing are registered by the user on the print server 10 in advance.

Next, the number of printers to be used in the cluster printing is obtained from the acquired printer identification information and the particular number of the printers is stored into the server side job management information (S104). The acquired printer identification information |is stored in| the server side job management information (S105).

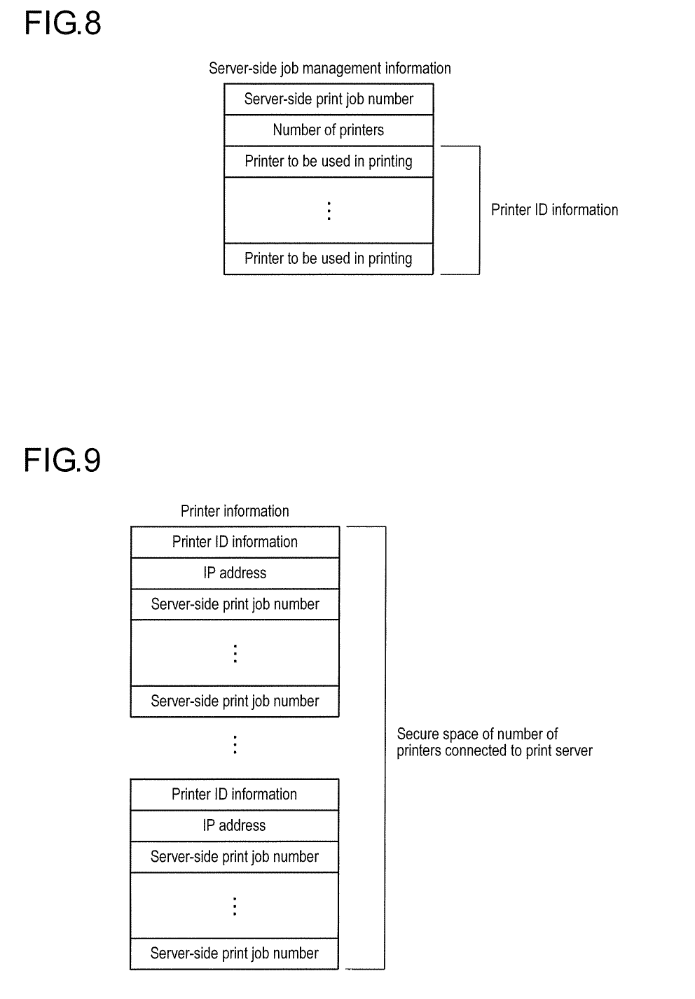

FIG. 8 is a diagram showing an example of the sever-side job management information. This server-side job management information is stored into the RAM 103 in the print server 10.

From the above procedures, the print server 10 |is| capable of managing the printers used in the cluster printing by each print job.

Next, the printer number counter is established and the printer number counter is initialized to “0” (S106).

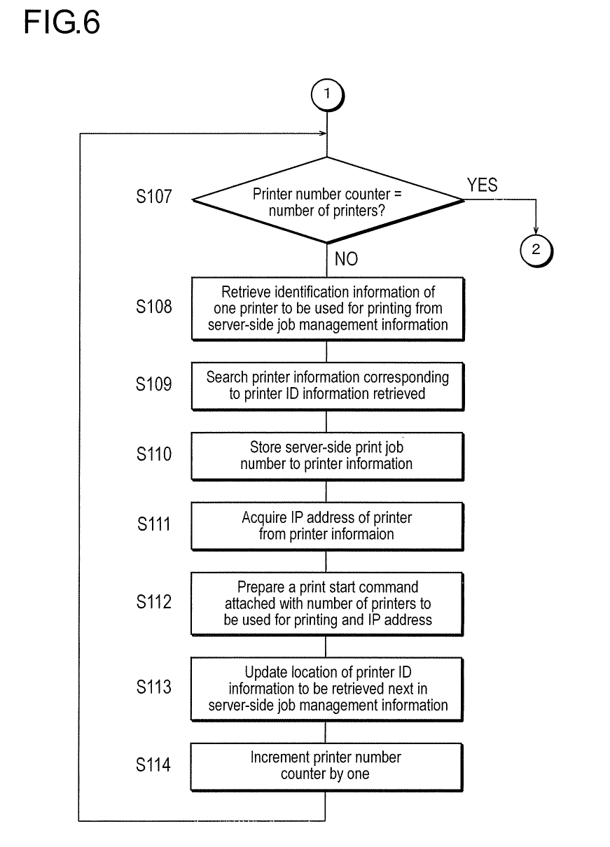

In the step S107 (refer to FIG. 6), a judgment is made as to whether or not the value of the printer number counter is equal to the number of printers used in the cluster printing.

When the printer number counter judges that its value is not equal to the number of printers used in the cluster printing (S107: No), the program advances to step S108.

In order to prepare the printer information to be described later for each printer, the number of process executions is controlled to be the number of printers in the steps S106 and S107.

In step S108, identification information of one printer to be used in the cluster printing is retrieved from the server-side management information.

Next, printer information corresponding to the retrieved printer identification information is searched (S109). At this point, the information concerning the printers to be used for the cluster printing, i.e., the printer information, is generated for each printer on the printer server 10 as the printers to be used in the cluster printing are registered on the print server 10. The printer information includes the printer identification information and the IP address corresponding to it.

Next, the server-side print job number is stored into the printer information searched in step S109 (S110).

FIG. 9 shows an example of the printer information. The printer information is stored in the RAM 103 of the printer server 10. As shown in FIG. 9, the printer information storage areas are provided as many as the number of printers used in the clustered printing and connected to the print server 10.

In step S111, the IP addresses of all the printers to be used in the cluster printing are acquired from the printer information.

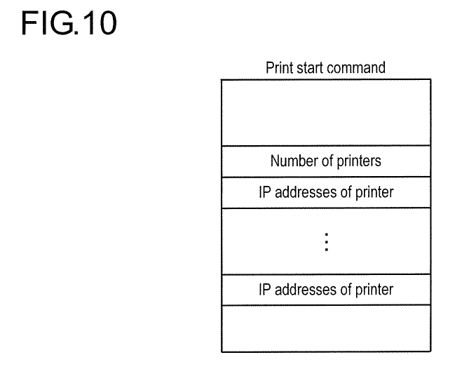

The print start command attached with the number and the IP addresses of the printers to be used for the cluster printer is prepared for the printer corresponding to the printer identification information retrieved in step S108 (S112). This print start command is one of the print start commands for the child print jobs prepared by splitting the print job to be executed. FIG. 10 is a diagram showing an example of the print start command.

Next, the location of the printer identification information to be retrieved next in the server-side job management information is updated (S113).

In step S114, the printer number counter is incremented by one, and the program returns to step S107.

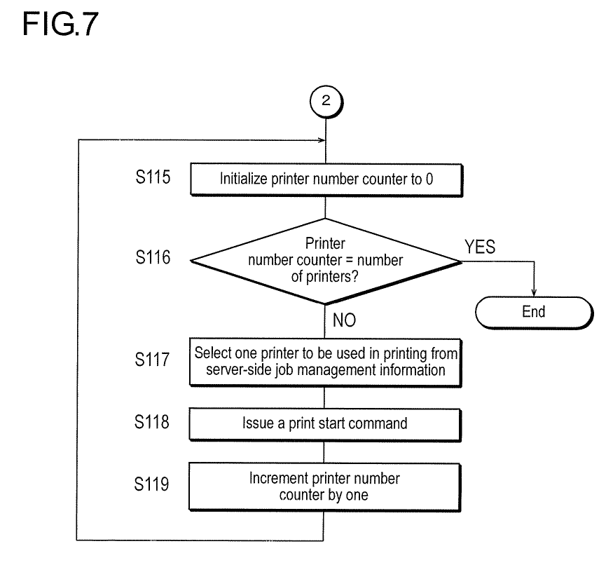

On the other hand, if the value of the printer number counter is judged to be equal to the number of printers to be used in the cluster printing in step S107 (S107: Yes), the program advances to step S115 (refer to FIG. 7).

In step S115, the printer number counter is initialized to “0.”

In step S116, a judgment is made as to whether or not the value of the printer number counter is equal to the number of printers used in the cluster printing.

When the printer number counter judges that its value is not equal to the number of printers (S116: No), the program advances to step S117.

In step S117, one printer is selected to be used in the cluster printing from the server-side management information.

Next, a print start command prepared in step S112 is issued to the selected printer (S118). Following the issuing of the print start command, page data to be printed at the selected printer is transmitted.

In step S119, the printer number counter is incremented by one, and the program returns to step S115.

On the other hand, if the value of the printer number counter is judged to be equal to the number of printers to be used in the cluster printing in step S116 (S116: Yes), the print start command transmission process is terminated.

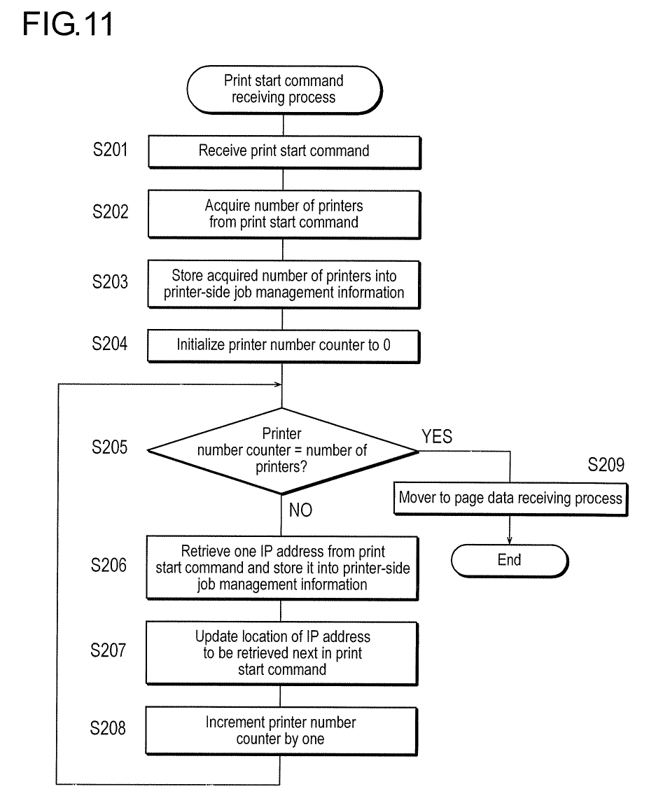

FIG. 11 is a flowchart showing the procedure of the print start command reception process on the printer 21. The algorithm illustrated by the flowchart of FIG. 11 is stored as a program in a storage unit such as the ROM 202 of the printer 21, read out to the RAM 203, and is executed by the CPU 201 when the operation starts. The print start command receiving process at the printers 22 and 23 are similar to the print start command receiving process at the printer 21.

Receiving the print start command from the print server 10 (S201), the printer 21 acquires the number of printers from the received print start command (S202). This number of printers is the number of the printers used in the cluster printing.

The acquired number of printers is then stored into the printer side job management information for which a memory area is reserved and managed in the printer 21 (S203).

Next, the printer number counter is established and the printer number counter is initialized to “0” (S204).

In the step S205, a judgment is made as to whether or not the value of the printer number counter is equal to the number of printers used in the cluster printing.

When the printer number counter judges that its value is not equal to the number of printers (S205: No), the program advances to step S206.

The number of executions of the process is controlled to be equal to the number of printers in steps S204 and 205 so that the IP addresses of all the printers used in the cluster printing are stored.

In step S206, one IP address is retrieved from the print start command and is stored into the printer-side job management information.

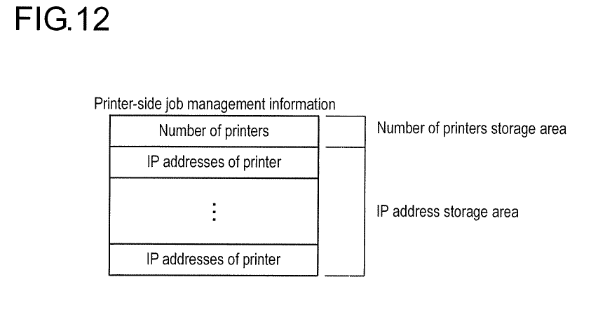

FIG. 12 is a diagram showing an example of the printer-side job management information. This server-side job management information is stored in the RAM 203 in the printer 21.

Next, the location of the IP address to be retrieved next in the print start command is updated (S207).

In step S208, the printer number counter is incremented by one, and the program returns to step S205.

On the other hand, if it is judged in step S205 that the value of the printer number counter is equal to the number of printers to be used in the cluster printing (S205: Yes), the program advances from the print start command receiving process to the receiving process of the page data to be printed (S209).

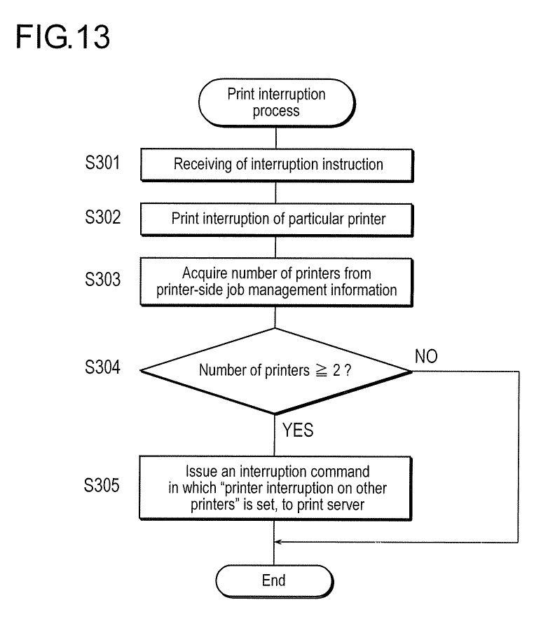

FIG. 13 is a flowchart showing the sequence of the print interruption process on the printer 21. The algorithm illustrated by the flowchart of FIG. 13 is stored as a program in a storage unit such as the ROM 202 of the printer 21, read out to the RAM 203, and is executed by the CPU 201 when the operation starts. The print interruption processes at the printers 22 and 23 are identical to the print interruption process in the printer 21.

Receiving an instruction for print interruption as the user notices an error in printed materials at the installed location of the printer 21 and depresses, for example, the stop button on the panel unit 204 of the printer 21 (S301), the printer 21 interrupts its own printing process (S302).

Next, it retrieves the number of printers from the printer-side job management information (refer to FIG. 12) (S303).

In step S304, a judgment is made as to whether or not the number of printers acquired in step S303 is two or more. If the number of printers is two or more, it means that there area other printers which are executing printing processes based on a print job corresponding to the interrupted printing, in other words, that the interrupted printing is one of the cluster printing operations performed on a plurality of printers.

If it is judged that there are two or more printers in step S304 (S304: Yes), the printer 21 issues an interruption command, in which “print interruption on other printers” is set, to the print server 10 (S305). In other words, an interruption command for executing the print interruption process on other printers 22 and 23 used in the cluster printing is issued to the print server 10, and the print interruption process shown in FIG. 13 is terminated.

On the other hand, if it is judged that the number of printers is not two or more in step S304 (S304: No), the print interruption process in FIG. 13 is terminated as is.

As can be seen in the above, when an instruction for print interruption is received based on the user's operation on the printer 21, printing operations on all the printers used in the cluster printing are interrupted immediately in the present embodiment.

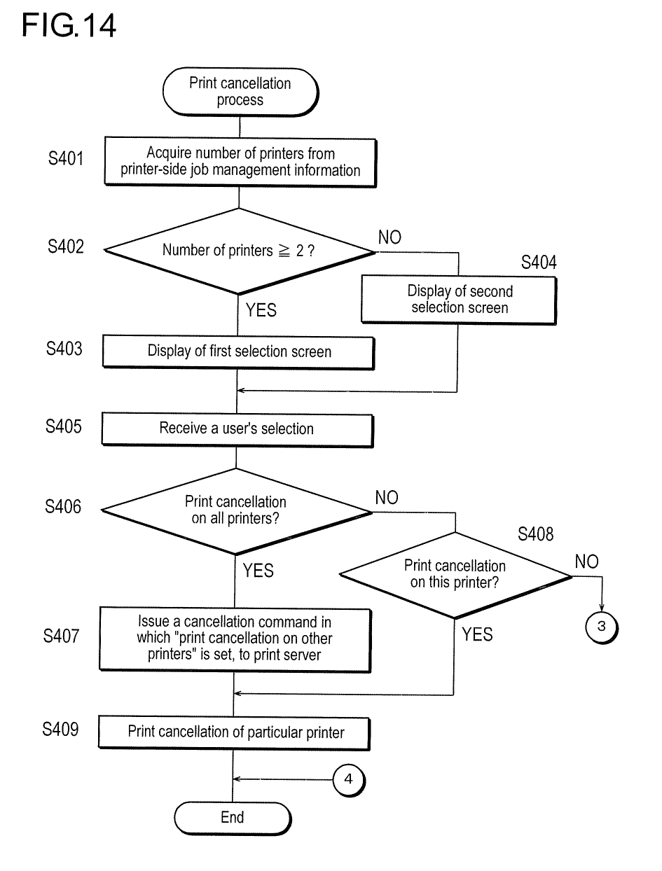

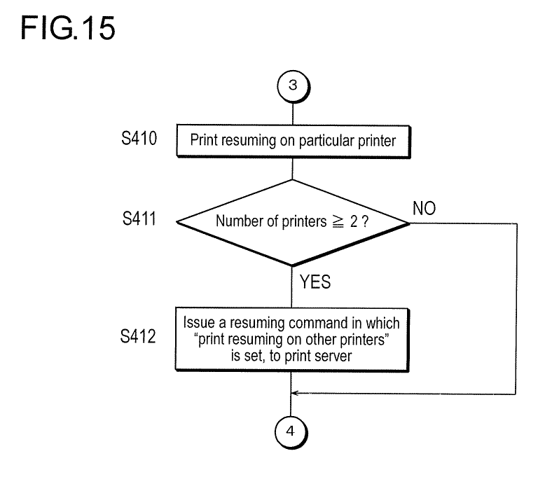

FIG. 14 and FIG. 15 represent a flowchart showing the procedure of the print cancellation process on the printer 21. The algorithm illustrated by the flowchart of FIG. 14 and FIG. 15 is stored as a program in a storage unit such as the ROM 202 of the printer 21, read out to the RAM 203, and is executed by the CPU 201 when the operation starts. The print cancellation processes at the printers 22 and 23 are identical to the print cancellation process in the printer 21.

The print cancellation process shown in FIG. 14 and FIG. 15 is executed following the print interruption process shown in FIG. 13.

First, it retrieves the number of printers from the printer-side job management information (refer to FIG. 12) (S401).

In step S402, a judgment is made as to whether or not the number of printers acquired in step S401 is two or more.

If it is judged that there are two or more printers in step S402 (S402: Yes), the printer 21 displays a first selection screen for receiving the user's selection on the operating panel unit 204 (S403).

FIG. 16 is a diagram showing an example of the first selection screen 510. The first selection screen 510 contains a button 511 for canceling its own printing operation, a button 512 for canceling the printing operations of all other printers used in the cluster printing, and a button 513 for continuing the printing operations (resuming the interrupted printing operations).

On the other hand, if it is negatively judged that there are two or more printers in step S402 (S402: No), the printer 21 displays a second selection screen for receiving the user's selection on the operating panel unit 204 (S404).

FIG. 17 is a diagram showing an example of the second selection screen 520. The second selection screen 520 contains a button 521 for canceling its own printing, and a button 522 for continuing the printing operation (resuming the interrupted printing operation).

In step S405, the user's selection on the first selection screen 510 or the second selection screen 520 is received.

A judgment is then made as to whether or not the user's selection received in step S405 is for print cancellation on all the printers (S406).

If it is judged that the user's selection is for print cancellation on all printers (S406: Yes), the printer 21 issues a cancellation command, in which “print cancellation of other printers” is set, to the print server 10 (S407). In other words, a cancellation command to execute the print cancellation process on other printers 22 and 23 used on the cluster printing is issued to the print server 10.

On the other hand, if the user's selection is not print cancellation on all printers (S406: No), a judgment is made as to whether or not the user's selection received in step S405 is for print cancellation on the own printer (S408).

If it is judged in step S408 that the user's selection is for print cancellation on the own printer (S408: Yes), the process advances to step S409.

In step S409, the printer 21 cancels its own printing operation. The issuing of the cancellation command (S407) can be done after the print cancellation on the own printer (S409).

If it is judged in step S408 that the user's selection is not for print cancellation on the own printer (S408: No), the process advances to step S410 (FIG. 15).

In step S410, the user's selection received in step S405 is judged to be a printing continuation (resuming) instruction, and the interrupted printing operation of its own is |resumed| (S410).

In step S411, a judgment is made as to whether or not the number of printers acquired in step S401 is two or more.

If it is judged that there are two or more printers in step S411 (S411: Yes), the printer 21 issues an resuming command in which “|resuming printings on other printers|” is set to the print server 10 (S412). In other words, a resuming command for executing the print resuming process on other printers 22 and 23 used in the cluster printing is issued to the print server 10, and the print cancellation process shown in FIG. 14 and FIG. 15 is terminated.

On the other hand, if it is judged that the number of printers is not two or more in step S411 (S411: No), the print cancellation process in FIG. 14 and FIG. 15 is terminated as is.

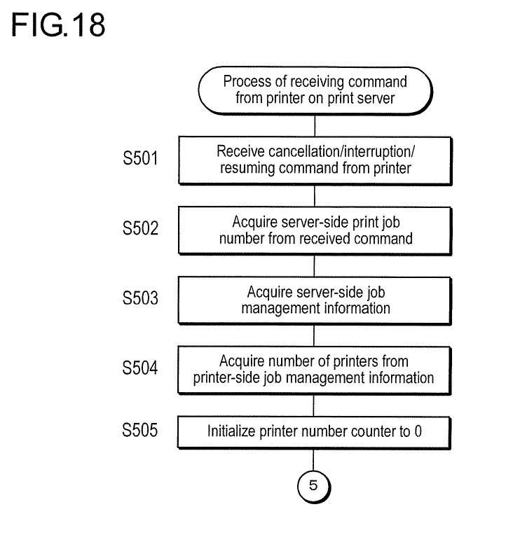

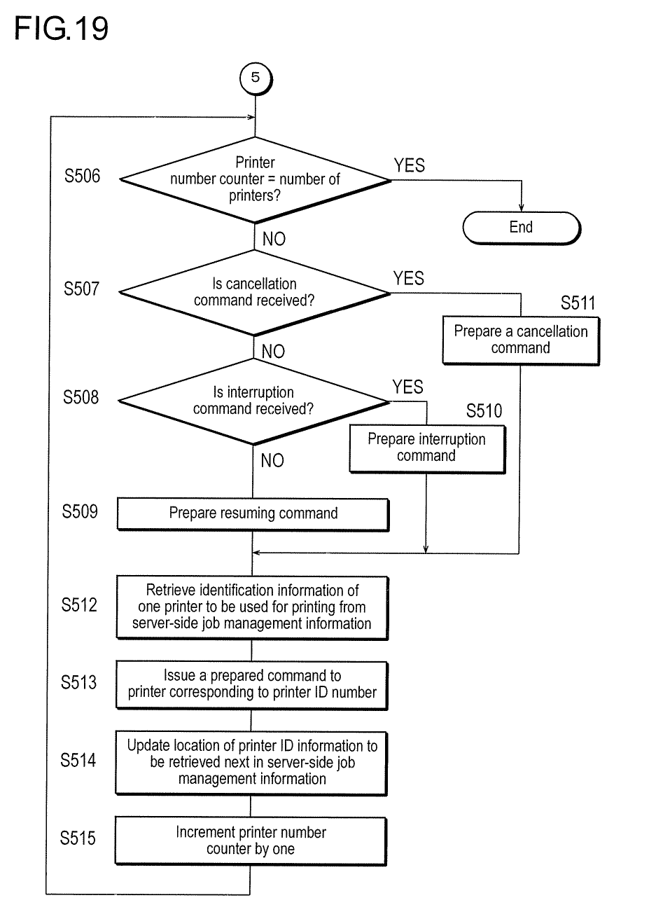

FIG. 18 and FIG. 19 represent a flowchart showing the procedure of the command reception from the printer on the print server 10. The algorithm illustrated by the flowchart of FIG. 18 and FIG. 19 is stored as a program in a storage unit such as the hard disk 104 of the print server 10, read out to the RAM 103 and executed by the CPU 101 when the operation starts.

Upon receiving a print cancellation, interruption or resuming command from the printer (e.g., printer 21) (S501), the print server 10 acquires a server-side print job number from the received command (S502).

Next, the server-side job management information acquired in step S502 (refer to FIG. 8) that corresponds to the server-side job number is acquired (S503).

Next, the number of printers is acquired from the server-side management information acquired in step S503 (S504). This number of printers is the number of the printers used in the cluster printing.

Next, the printer number counter is established and the printer number counter is initialized to “0” (S505).

In the step S506 (refer to FIG. 19), a judgment is made as to whether or not the value of the printer number counter is equal to the number of printers used in the cluster printing.

When it is judged that the value of the printer number counter is not equal to the number of printers used in the cluster printing (S506: No), the program advances to step S507.

The number of executions of the process is controlled to be equal to the number of printers in steps S505 and 506 in order to cause all the printers used in the cluster printing to interrupt, cancel or resume their printing operations.

In step S507, the command received in step S501 is judged as to whether it is a cancellation command.

If it is judged that the received command is a cancellation command (S507: Yes), a cancellation command for all the printers used in the cluster printing to execute print cancellation processes is prepared (S511).

Otherwise, if it is judged that the received command is an interruption command (S507: No, S508: Yes), an interruption command for all the printers used in the cluster printing to execute print interruption processes is prepared (S510).

Otherwise, if it is judged that the received command is a resuming command (S507: No, S508: No), a resuming command for all the printers used in the cluster printing to execute print resuming processes is prepared (S509).

In step S512, identification information of one printer to be used in the cluster printing is retrieved from the server-side management information acquired in step 503.

In step S513, a command prepared in either of steps S509 through S511 is issued to the printer corresponding to the retrieved printer identification information.

However, the command prepared in either one of steps S509 through S511 in the present embodiment is not transmitted to a printer, which is the issuer of the command to the print server 10 received in step S501. This is because the process that corresponds to the particular command has already been executed in the printer, which is the issuer of the command to the print server 10. Alternatively, it can also be so constituted in such a way that the process that corresponds to the particular command is not executed initially in the printer which is the issuer of the command to the print server 10, and that commands transmitted to each printer from the print server 10 are executed at each printer respectively.

Next, the location of the printer identification information to be retrieved next in the server-side job management information is updated (S514).

In step S515, the printer number counter is incremented by one, and the program returns to step S506.

On the other hand, if the value of the printer number counter is judged to be equal to the number of printers to be used in the cluster printing in step S506 (S506: Yes), the process of receiving command from the printer at the print server shown in FIG. 18 and FIG. 19 is terminated.

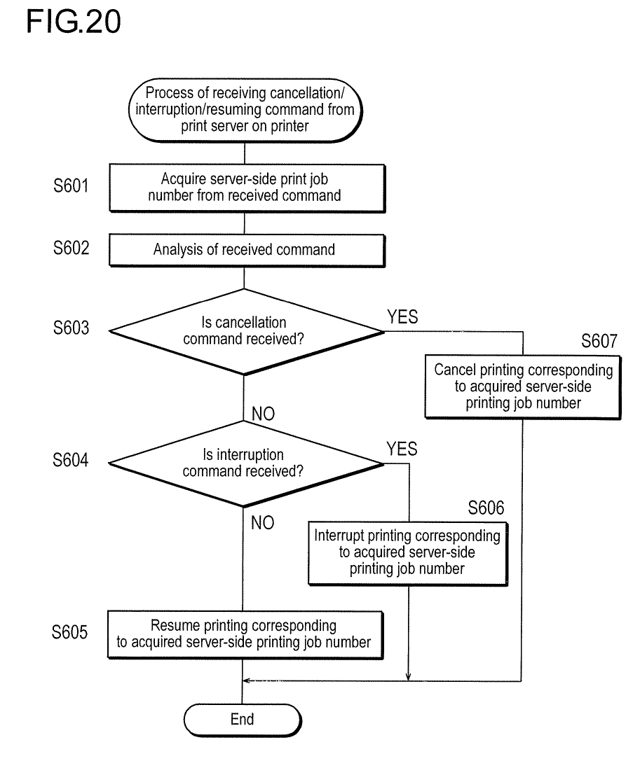

FIG. 20 is a flowchart showing the procedure of the process of cancellation/interruption/resuming command reception from the print server on the printer 22. The algorithm illustrated by the flowchart of FIG. 20 is stored as a program in a storage unit such as the ROM 202 of the printer 22, read out to the RAM 203, and is executed by the CPU 201 when the operation starts. The process of cancellation/interruption/resuming command reception from the print server on the printers 21 and 23 are identical to the process on the printer 22.

Upon receiving a print cancellation, interruption or resuming command from the print server 10, the printer (e.g., printer 22) acquires a server-side print job number from the received command (S601).

Next, the received command is analyzed (S602), and a judgment is made as to whether or not the received command is a cancellation command (S603).

If the received command is judged to be a cancellation command (S603: Yes), the printing that corresponds to the server-side print job number acquired in step S601 is cancelled (S607).

Otherwise, if the received command is judged to be an interruption command (S603: No, S604: Yes), the printing that corresponds to the server-side print job number acquired in step S601 is interrupted (S606).

Otherwise, if the received command is judged to be a resuming command (S603: No, S604: No), the printing that corresponds to the server-side print job number acquired in step S601 is resumed (S605).

As such, in the present embodiment, if a user's instruction concerning at least one of print interruption and print cancellation is received by one of the printers while a print job is being executed split among a plurality of printers, a command for causing other printers that are executing printing processes based on the print job to execute a process corresponding to the abovementioned instruction is issued from the abovementioned printer.

According to the present embodiment, when the user notices an error in the printed materials at the installation location of the one particular printer among a plurality of printers, the user can cause the particular one of the printers to issue a command to execute a process that corresponds to a print interruption or cancellation instruction that the user issues to the one particular printer. Consequently, wasteful printing can be quickly suppressed, so that consumption of consumable items due to wrong print can be reduced, reducing the overall printing cost.

Next, the second embodiment of the invention will be described below. In the following paragraphs, only the differences from the abovementioned first embodiment will be described, omitting the descriptions on points that are identical to those in the first embodiment.

As can be seen in the above, when an instruction for print interruption is received based on the user's operation on the printer 21, printing operations on all the printers used in the cluster printing are interrupted immediately in the first embodiment. However, in the second embodiment, a selection screen is provided for receiving the user's selection on whether or not to interrupt the printing on other printers used for the cluster printing when an instruction for print interruption is received by the printer 21 based on the user's operation.

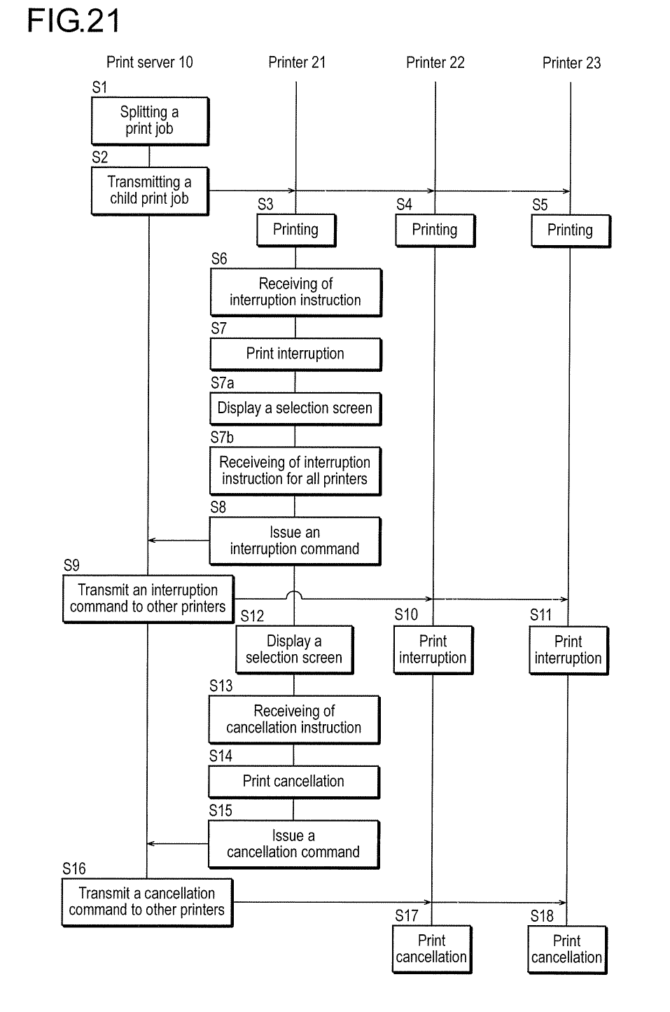

FIG. 21 is a sequence chart for describing the outline of the operation of the image forming system concerning the second embodiment

The sequence chart shown in FIG. 21 is different from the sequence chart shown in FIG. 4 in that steps S7a and S7b are inserted. Only the difference of the sequence chart shown in FIG. 21 from that of FIG. 4 will be described below.

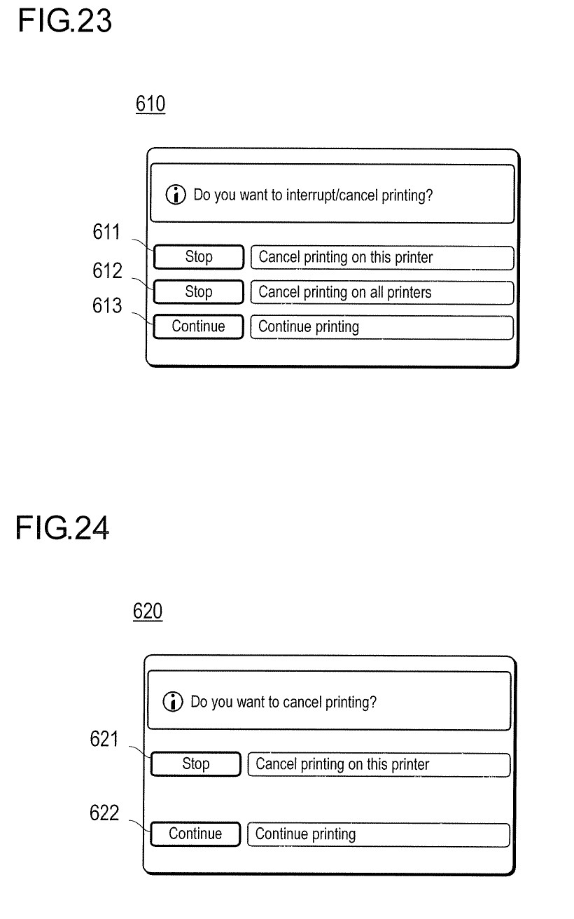

When an instruction for print interruption based on the user's operation is received by the printer 21 (S6) in the second embodiment, the printer 21 not only interrupts its printing operation (S7), but also displays a selection screen for receiving the user's selection on whether to interrupt printing or continue printing in all other printers used for the cluster printing on the operating panel unit 204 (S7a, refer to FIG. 23).

Let us describe here the case in which a selection of interrupting the printing operation on all printers used for the cluster printing is received (S7b). In this case, the printer 21 issues an interruption command for causing other printers 22 and 23 used for the cluster printing to execute the print interruption process to the print server 10 (S8).

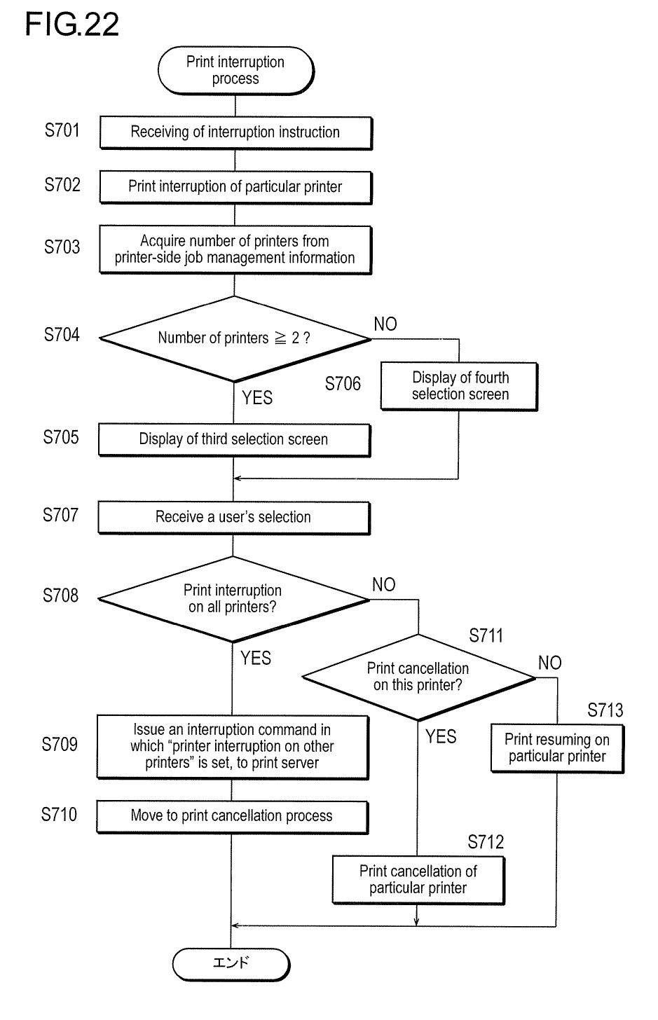

FIG. 22 is a flowchart showing the sequence of the print interruption process on the printer 21 in the second embodiment. The algorithm illustrated by the flowchart of FIG. 22 is stored as a program in a storage unit such as the ROM 202 of the printer 21, read out to the RAM 203, and is executed by the CPU 201 when the operation starts. The print interruption processes at the printers 22 and 23 are identical to the print interruption process in the printer 21.

Since the steps S701 through S704 are identical to the steps S301 through S304 shown in FIG. 13, their descriptions are omitted.

If it is judged that there are two or more printers in step S704 (S704: Yes), the printer 21 displays a third selection screen for receiving the user's selection on the operating panel unit 204 (S705).

FIG. 23 is a diagram showing an example of the third selection screen 610. The third selection screen 610 contains a button 611 for canceling its own printing operation, a button 612 for interrupting the printing operations of all other printers used in the cluster printing, and a button 613 for continuing the printing operations (resuming the interrupted printing operations).

On the other hand, if it is judged that the number of printers is not two or more in step S704 (S704: No), the printer 21 displays a fourth selection screen for receiving the user's selection on the operating panel unit 204 (S706).

FIG. 24 is a diagram showing an example of the fourth selection screen 620. The fourth selection screen 620 contains a button 621 for canceling its own printing, and a button 622 for continuing the printing operation (resuming the interrupted printing operation).

In step S707, the user's selection on the third selection screen 610 or the fourth selection screen 620 is received.

A judgment is then made as to whether or not the user's selection received in step S707 is for canceling the printing operations on all the printers (S708).

If it is judged that the user's selection is to interrupt the printing operations on all printers (S708: Yes), the printer 21 issues an interruption command, in which “print interruption on other printers” is set, to the print server 10 (S709). In other words, an interruption command to execute the print interruption process on other printers 22 and 23 used on the cluster printing is issued to the print server 10.

When the process of step S709 is completed, the program moves to the print cancellation process (FIG. 14) (S710).

On the other hand, if the user's selection is not for print interruption on all printers (S708: No), a judgment is made as to whether or not the user's selection received in step S707 is the print cancellation on the own printer (S711).

If it is judged that the user's selection is for print cancellation on the own printer in step S711 (S711: Yes), the printer 21 cancels its own printing operation (S712).

On the other hand, if it is judged that the user's selection is not for print cancellation on the own printer in step S711 (S711: No), the particular printer's own printing, which has been interrupted, is resumed based on a judgment that the user's selection received in step S707 is to continue (resume) the printing operation (S713).

Thus, in the second embodiment, when an instruction for print interruption is received at one of the printers during an execution of a print job split among a plurality of printers, the user's selection for whether or not to execute a print interruption process on other printers can be received. When the selection of executing a print interruption process on other printers is received, an interruption command for executing the interruption process is issued from the abovementioned one of the printers.

In other words, the printing on the printer, for which the instruction for print interruption is received, is interrupted first, and the user can select either to execute the print interruption on other printers or not. Therefore, the second embodiment can not only provide the same operational effect as in the first embodiment, but also meet various other requests of the user.

Next, the third embodiment of the invention will be described below. In the following paragraphs, only the differences from the abovementioned first embodiment will be described, omitting the descriptions on points that are identical to those in the first embodiment.

In the first embodiment, after the command for print cancellation, interruption or resuming is issued from the one particular printer to the print server, it is transmitted from the particular print server to other printers. However, in the third embodiment, the command for print cancellation, interruption or resuming is issued by the one particular printer to other printers directly without going through the print server. The command for print cancellation, interruption or resuming is issued according to the IP addresses included as the address information of other printers in the print start command received by the one particular printer. Thus, the IP addresses of other printers are used for issuing a print cancellation, interruption or resuming command from the one particular printer to other printers directly. This means that the IP addresses of other printers need not necessarily be included in the print start command in the first embodiment.

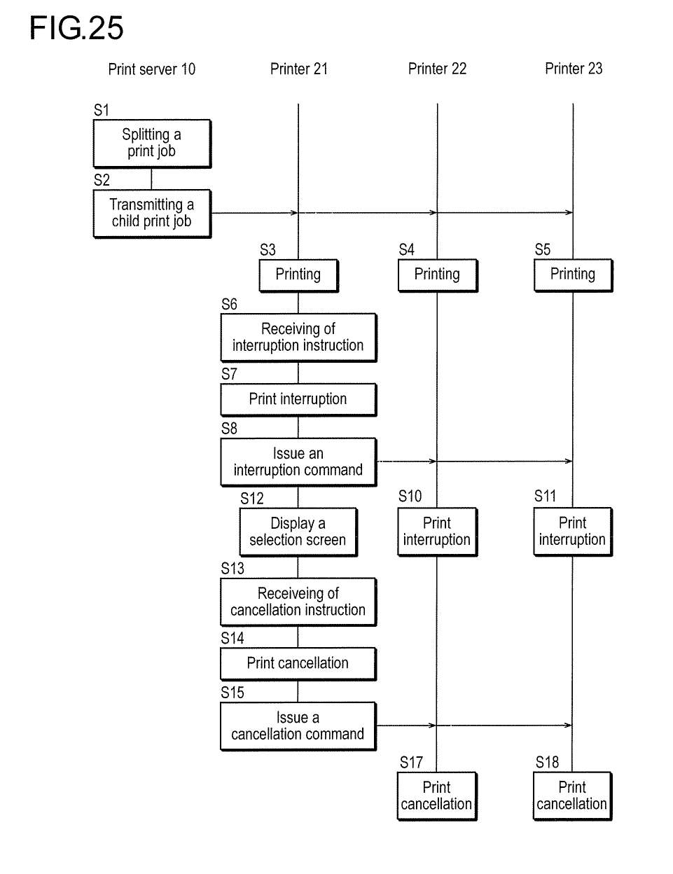

FIG. 25 is a sequence chart for describing the outline of the operation of the image forming system concerning the third embodiment of the present invention.

Only the difference of the sequence chart shown in FIG. 25 from that of FIG. 4 will be described below.

In the third embodiment, the printer 21 issues in step S8 an interruption command for executing print interruption process on other printers 22 and 23 used in the cluster printing directly to other printers 22 and 23 without going through the print server 10. Thus, step S9 is omitted.

Also, the printer 21 issues in step S15 a cancellation command for executing print cancellation process on other printers 22 and 23 used in the cluster printing directly to other printers 22 and 23 without going through the print server 10. Thus, step S16 is omitted.

As such, the third embodiment can provide, in addition the same operational effect as in the first embodiment, but also the benefit of quick transmission of a print cancellation, interruption, or resuming command from the one particular printer to other printers.

Next, the fourth embodiment of the invention will be described below. In the following paragraphs, only the differences from the abovementioned first embodiment will be described, omitting the descriptions on points that are identical to those in the first embodiment.

In the first embodiment, the command for print cancellation, interruption or resuming is transmitted from the print server to other printers after being issued from one print to the particular print server. However, in the fourth embodiment, a print cancellation, interruption or resuming command is first issued from the one particular printer to a printer which serves as a parent printer by which the print job is split among a plurality of printers, and then transmitted from the parent printer to other printers.

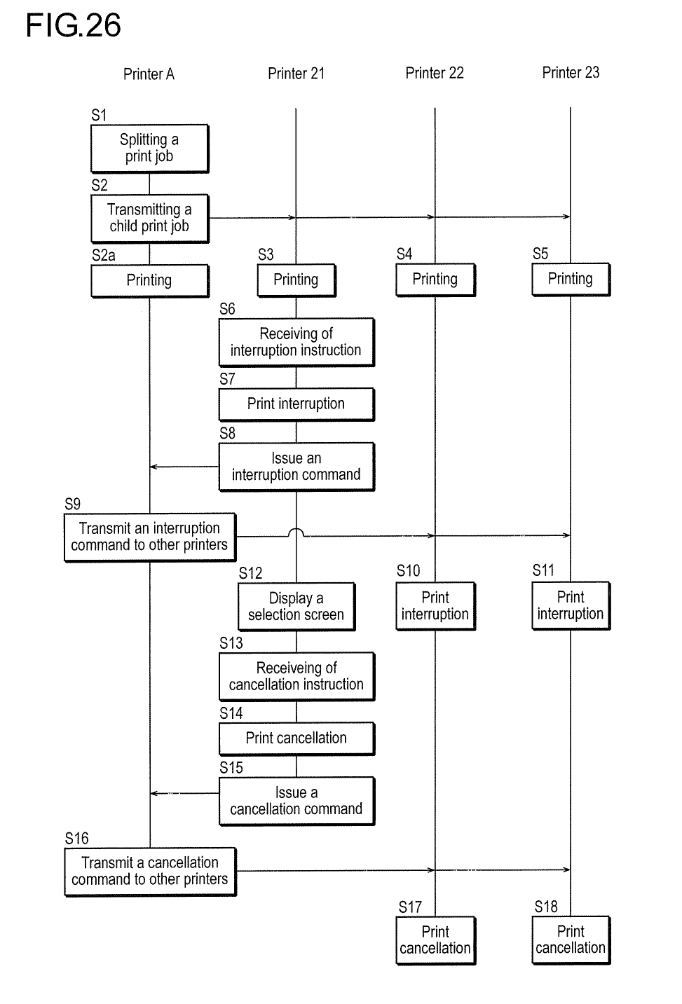

FIG. 26 is a sequence chart for describing the outline of the operation of the image forming system concerning the fourth embodiment of the present invention.

Only the difference of the sequence chart shown in FIG. 26 from that of FIG. 4 will be described below.

In the fourth embodiment, a printer that serves as the parent printer splits the print job to be assigned to other printers. In FIG. 26, the printer A is the parent printer.

In other words, the printer A splits the print job to be executed (S1), forms a plurality of child print jobs, and transmits them to the printers 21-23 individually (S2).

Next, while the printer A executes its own assigned printing as the parent (S2a), other printers 21-23 also execute printing based on child print jobs they received respectively (S3-S5). The rest of the process is identical to that of the first embodiment.

As such, the fourth embodiment is applicable to a cluster printing style where a parent printer splits a print job among child printers which are locally connected to the parent printer to provide the same operational effect as in the first embodiment.

It is obvious that this invention is not limited to the particular embodiments shown and described above but may be variously changed and modified without departing from the technical concept of this invention.

For example, each of the abovementioned embodiments can be implemented by arbitrarily combining themselves as much as possible.

It is also possible to use, in place of a printer, an image forming apparatus such as a facsimile machine, a copying machine, or an MFP (multi-function peripheral) that has a combination of their functions.

The means and method of conducting various processes in the image forming system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a memory unit such as a hard disk. Said program can also be provided as independent application software or can be built into the software of the device as a part of its function.

What is claimed is:

1. An image forming system capable of executing a print job by splitting the print job among a plurality of image forming apparatuses, comprising:
an instructing unit for receiving a user's instruction concerning at least one of print interruption and print cancellation at one of said plurality of image forming apparatuses; and
an issuing unit for issuing from said one particular image forming apparatus a command for causing other image forming apparatus, which is executing a printing process based on the print job corresponding to said printing among said plurality of image forming apparatuses, to execute a process corresponding to said instruction, when said instruction is received by said instruction unit.

2. The image forming system as claimed in claim 1, further comprising
a selecting unit for receiving the user's selection as to whether or not to cause said other image forming apparatus to execute a process corresponding to said instruction when said instruction is received by said instructing unit, wherein
said issuing unit issues said command when a selection to cause said other image forming apparatus to execute the process corresponding to said instruction is received by said selecting unit.

3. The image forming system as claimed in claim 1, wherein
after said command is issued by said one particular image forming apparatus to a print server that manages the execution of said print job, said command is transmitted to said other image forming apparatus from said print server.

4. The image forming system as claimed in claim 1, wherein
said command is issued by said one particular image forming apparatus to said other image forming apparatus.

5. The image forming system as claimed in claim 4, wherein
said command is issued according to the address information of said other image forming apparatus contained in a print start command said one particular image forming apparatus received.

6. The image forming system as claimed in claim 1, wherein
said command is, after being issued to an image forming apparatus, which acts as a parent for splitting said print job among said plurality of image forming apparatuses, transmitted to said other image forming apparatus from said image forming apparatus acting as the parent.

7. The image forming system as claimed in claim 1, wherein
the user's instruction concerning said at least one of print interruption and print cancellation contains the user's instruction for resuming the interrupted printing.

8. An image forming apparatus of an image forming system capable of executing a print job by splitting the print job among a plurality of image forming apparatuses, comprising:
an instructing unit for receiving a user's instruction concerning at least one of print interruption and print cancellation; and
an issuing unit for issuing a command for causing other image forming apparatus, which is executing a printing process based on the print job corresponding to said printing among said plurality of image forming apparatuses, to execute a process corresponding to said instruction, when said instruction is received by said instruction unit.

9. The image forming apparatus as claimed in claim 8, further comprising
a selecting unit for receiving the user's selection as to whether or not to cause said other image forming apparatus to execute a process corresponding to said instruction when said instruction is received by said instructing unit, wherein
said issuing unit issues said command when a selection to cause said other image forming apparatus to execute the process corresponding to said instruction is received by said selecting unit.

10. The image forming apparatus as claimed in claim 8, wherein
said issuing unit, in order to transmit said command to said other image forming apparatus from a print server that manages the execution of said print job, issues said command to said print server.

11. The image forming apparatus as claimed in claim 8, wherein
said issuing unit issues said command to said other image forming apparatus.

12. The image forming apparatus as claimed in claim 11, wherein
said command is issued according to the address information of said other image forming apparatus contained in a print start command received.

13. The image forming apparatus as claimed in claim 8, wherein
said issuing unit issues, in order to transmit said command to said other image forming apparatus from an image forming apparatus acting as a parent for splitting said print job among said plurality of image forming apparatuses, issues said command to said image forming apparatus acting as the parent.

14. The image forming apparatus as claimed in claim 8, wherein
the user's instruction concerning said at least one of print interruption and print cancellation contains the user's instruction for resuming the interrupted printing.

15. A print server of an image forming system comprising a plurality of image forming apparatuses, and the print server that executes management of a print job by splitting the print job among said plurality of image forming apparatuses, comprising:
a receiving unit for receiving a command from an image forming apparatus among said plurality of image forming apparatuses for causing said other image forming apparatus to execute a process corresponding to a user's instruction concerning at least one of print interruption and print cancellation; and
a transmitting unit for transmitting, when said command is received by said receiving unit, said command to other image forming apparatus executing a printing process based on the print job corresponding to said printing among said plurality of image forming apparatuses.

16. The print server as claimed in claim 15, wherein
the user's instruction concerning said at least one of print interruption and print cancellation contains the user's instruction for resuming the interrupted printing.

17. An image forming method for executing a print job by splitting the print job among a plurality of image forming apparatuses, comprising:
(a) receiving a user's instruction concerning at least one of print interruption and print cancellation at one of said plurality of image forming apparatuses; and
(b) issuing from said one particular image forming apparatus a command for causing other image forming apparatus, which is executing a printing process based on the print job corresponding to said printing among said plurality of image forming apparatuses, to execute a process correspond to said instruction, when said instruction is received in said step (a).

18. A computer readable recording medium stored with an image forming program for controlling an image forming apparatus of an image forming system capable of executing a print job by splitting the print job among a plurality of image forming apparatuses, said image forming program causing said image forming apparatus to execute a process comprising:
(a) receiving a user's instruction concerning at least one of print interruption and print cancellation; and
(b) issuing a command for causing other image forming apparatus, which is executing a printing process based on the print job corresponding to said printing among said plurality of image forming apparatuses, to execute a process corresponding to said instruction, when said instruction is received in said step (a).

19. A computer readable recording medium stored with an image forming program for controlling a print server of an image forming system comprising a plurality of image forming apparatuses and the print server that executes management of a print job by splitting the print job among said plurality of image forming apparatuses, said image forming program causing said print server to execute a process comprising:
(a) receiving a command from an image forming apparatus among said plurality of image forming apparatuses for causing said other image forming apparatus to execute a process corresponding to a user's instruction concerning at least one of print interruption and print cancellation; and
(b) transmitting, when said command is received in said step (a), said command to other image forming apparatus executing a printing process based on the print job corresponding to said printing among said plurality of image forming apparatuses.
